(19) United States
(12) Patent Application Publication
(10) Pub. No.: US 2025/0361749 A1
(43) Pub. Date: Nov. 27, 2025

(54) Electric Door Lock Device

(71) Applicant: Pin Genie Inc., San Francisco, CA (US)

(72) Inventor: Li Zheng, Kwun Tong (HK)

(73) Assignee: Pin Genie Inc., San Francisco, CA (US)

(21) Appl. No.: 18/673,558

(22) Filed: May 24, 2024

(51) Int. Cl. E05B 47/06; E05B 13/00

(52) U.S. Cl. CPC E05B 47/0673; E05B 13/004; E05B 47/0696

(57) ABSTRACT

An electronic door lock device and an electronic door lock provides electronic components on a strike plate side of a door frame rather than inside the actual door, which is a limitation to conventional electronic door lock devices. The unique design provides for flexibility in using standard doorknobs that otherwise could not be used in an electronic door lock. Electrical wiring connection need not involve the door itself for allowing flexibility in use of any door and for avoiding any disconnection of electrical wiring due to door movement when the door is opened and closed. An electromagnetic expansion block moves an auxiliary latch that locks a cam for preventing the doorknob from rotating when locked. The cam is in contact with a link strip that engages a locking tongue to lock the door. Alternatively, a blocking block moved by an electromagnetic module may be used to lock the cam.

### TECHNICAL FIELD

The present disclosure relates to the field of electric door locks, in particular to an electric door lock device and an electric door lock that is powered from the door frame side instead of the door lock or from the door.

### BACKGROUND

In smart electronic door locks have been used in commercial and residential properties for many years with some success. The ability to open doors independent of a physical key has been widely accepted. In addition, some smart electronic door locks offer the ability for remote locking and unlocking for the user's convenience. Further key codes in a smart electronic door lock can be quickly and easily changed by the user. While changing physical locks and keys involves a more complicated process for example like changing hardware. In addition physical keys can get lost while smart electronic door lock can use key codes or biometric indicators such as a fingerprint rather than a physical key.

However despite these advantages, current state of the art smart electronic door locks still have several disadvantages. For example, many electronic door locks are powered by battery that require periodic changing of batteries in the door lock. In addition the loss of power due to uncharged batteries may result in the user being locked out of the property.

Another disadvantage of current state of the art electronic door locks is that the components such as electronic circuitry and mechanical motor parts are located in the door and/or the door handle. These components inside the door may get damaged or stop functioning by motion of the door slamming when opening and closing.

Furthermore the current state of the art smart locks have limited hardware for doorknobs and locks. Standard doorknobs and doorknobs with various designs are unavailable for use with the current state of the art electronic doorknobs because the smart electronic door lock requires specialized doorknobs particular to the specific smart lock. This limited design for smart lock doorknobs reduces the design choices and aesthetic requirements for property owners

In addition, many smart lock devices that are hard wired to an electrical power source require the door to be drilled out to accommodate wire placement through the door. Drilling passageways for wiring through a door may be difficult especially for fire doors that have certain requirements and it certain instances cannot be drilled out. Custom doors or other door customization may be required for wiring to the electronic lock in door. It would be desirable to have a smart lock that is wired to a property's power source or other power source and allows the use of standard doorknobs and standard doors without the need for customization.

Thus, there still exists a critical need for an electronic smart door lock that allows use of standard doorknobs and standard doors without the need for drilling into the door to accommodate for wiring to the electronic lock. In addition, there still remains a need for a smart lock to be wired to continuous power source and avoid any damage to the electronic lock components by door impact when opening and closing the door.

### SUMMARY

The present disclosure aims to solve at least one of the technical problems existing in the current state of the art, and provides many more benefits. Accordingly, the present disclosure provides an electronic door lock device that is powered by a power source 40 including, but not limited to, the property's electrical power, solar power, rechargeable lithium battery power, external power not from the property, power generated inside the locking device, wireless charging of the locking device either by contact charging or noncontact charging, or any other reliable power source, thereby improving the continuation of use of the electronic smart lock and overall user experience.

The present disclosure also provides for an electronic door lock device and/or an electronic door lock where the electronic components or at least some of the components are on a strike plate side of a door frame rather than inside the actual door. This arrangement provides for flexibility in using standard doorknobs that otherwise could not be used in an electronic door lock. The electrical wiring connection of the present disclosure is through the strike plate and need not involve the door itself. Having wiring in this area allows more flexibility in using any door, without modification, and without the need to drill for passage of electrical wires. In addition, having the components and wiring outside the door avoids any disconnection of electrical wiring or damage to electrical components due to door movement when the door is opened and closed.

In one aspect, an expansion block moves an auxiliary latch that locks a cam for preventing the door's doorknob from rotating when locked. The cam is in contact with a link strip that engages a locking tongue to lock the door. The electronic door lock is unlocked when an electronic key is inputted into the device. The electronic key includes, but is not limited to, a fingerprint, a password, a user interface input, a wireless token, a keycard, a retina scan, a biometric reading, facial recognition technologies, Nfc, Rfid, Radio frequency remote control, and the like. After input of the electronic key, an electric module drives the expansion block to retract, and an auxiliary latch spring extends the auxiliary latch. The auxiliary latch detaches from the groove in the cam allowing the cam to rotate when a user turns the doorknob shaft. The cam rotation drives the link strip to move and the link strip drives a locking tongue to retract from the strike plate to unlock the door.

In another aspect, a blocking block moved by an electromagnetic module may be used to lock the cam. A distal end of the blocking block is inserted into the groove of the cam to lock the cam. The blocking block may be moved towards the cam by a blocking block spring, electromagnetic force, and the like. The door is unlocked when the electronic key is inputted and the electromagnetic module generates a magnetic field moving the blocking block toward the electromagnetic module. Once the blocking block detaches from the cam the cam is free to rotate. The cam's rotation drives the link strip to move and the link strip drives the locking tongue to retract from the strike place and unlock the door.

The present disclosure also provides a door lock with the above- mentioned door lock device. The door lock includes a deadbolt having a locking tongue and depending on the implementation a cam and/or a moving mechanism that may or may not contain a printed circuit board assembly (PCBA).

A door lock device according to an embodiment of an aspect of the present disclosure includes:
a strike assembly and a lock body, the strike assembly includes a power module that operatively performs as either an electric power module or an electromagnetic power position or where the power module is an electric power module or an electromagnetic power module.

The strike assembly further includes an expansion block disposed in the electric power module that drives an auxiliary latch; or a blocking block outside the electromagnetic power module are either used to lock a cam, the cam is capable of connection to a doorknob shaft and a standard doorknob or any doorknob.

The lock body includes the cam is capable of rotating or otherwise moving about the cam's center wherein the center of the cam defines a hole for the doorknob shaft to enter therethrough; the cam further defines a groove for either a distal end of the auxiliary latch or a distal end of the blocking block to enter and lock the cam; the cam also having a plurality of protrusions that move in a circular directional path or other movement when the door is locked and unlocked.

Further included in the locking device, depending on the implementation, may include a cam locking member that may be either the auxiliary latch or the blocking block is disposed between the power module and the cam for engaging with the groove in the cam. A link strip is in contact with the cam's plurality of protrusions, wherein movement of the linked strap is controlled by movement of the plurality of protrusions. A locking tongue mechanism controlled by movement of the link strip may also be included.

The locking tongue mechanism may also include a locking tongue body having a locking tongue, a locking tongue spring disposed on the body, a locking tongue position piece, and a locking tongue cap; the locking tongue body being in contact with the link strip where the link strip may be disposed between the cap and locking tongue position piece. The locking tongue is capable of retracting and extending into a doorframe strike plate wherein, when a door in the doorframe is closed the locking tongue is extended into the doorframe strike plate and the cam locking member moves towards the cam and engages the groove for locking the cam and preventing the cam from rotating and maintaining the door locked.

Further, depending on the implementation, when an electronic key is inputted either wireless, by a user interface or other means then either the expansion block moves toward the electric module to release the distal end of the auxiliary latch from the groove of the cam; or the electromagnetic module generates a magnetic field moving the blocking block closer towards the electromagnetic module releasing the distal end of the blocking block from the groove of the cam; the cam is now free to rotate when a doorknob shaft is turned and moves the link strip to retract the locking tongue from the strike plate and unlocking the door.

The door lock device according to the embodiment of the present disclosure may also include at least the following beneficial effects: no drilling or wiring is needed inside the door; any door may be used with the present disclosure as well as any doorknob or door design; no batteries are needed to be replaced in the present disclosure's electronic door lock device; electronic components and hardware are removed from the door reducing the threat of damage by the door being forcibly shut or opened; and user still maintains the other benefits of current electronic door lock devices.

According to some embodiments of the present disclosure, the electronic locking device includes:
a power module for driving either an expansion block in contact with an auxiliary latch, or only a blocking block;
a cam for receiving a doorknob shaft, the cam having protrusions for moving a link strip; the cam further defining a groove wherein either a distal end of the auxiliary latch engages the groove or a distal end of the blocking block engages the groove to lock the cam and door; and
wherein when an electronic key is inputted either the auxiliary latch or the blocking block are released from the groove of the cam allowing the cam to rotate and move the link strip that releases a locking tongue for the door to open.

In yet another embodiment, an electric door lock device includes: a strike assembly and a deadbolt assembly disposed about a doorframe and a door; the strike assembly including a power source for delivering electricity to a strike electrode or an energy transmission end; the strike electrode or the energy transmission end having an opening on one side of the door frame; the deadbolt assembly including a deadbolt electrode or an energy receiving end, a moving mechanism, and a locking tongue; wherein, after the door is closed the power source delivers electricity to the strike electrode or the energy transmission end that powers the deadbolt electrode or the energy receiving end that supplies power to the moving mechanism; a user interface or an electronic key for controlling the electric door lock device; and wherein after a user inputs a lock unlocking command the moving mechanism receives the command and drives the locking tongue to retract from the strike assembly and unlock the door.

In still another embodiment an electric door lock device includes: a strike assembly and a deadbolt assembly disposed about a doorframe having an opening on one side and a door; the strike assembly including a power source for delivering electricity to an electrode 1 or an energy transmission end; wherein the electrode 1 or the energy transmission end delivers power to an electrode 2 or an energy receiving end; the deadbolt assembly including a printed circuit board assembly (PCBA) in communication with electrode 2 or the energy receiving end through conducting medium and a moving mechanism in communication with a locking tongue; wherein, after the door is closed the power source delivers electricity to the electrode 1 or a strike electrode or the energy transmission end that powers the electrode 2 or a deadbolt electrode or the energy receiving end that supplies power to the PCBA, and the PCBA powers the moving mechanism; a user interface or an electronic key for controlling the electric door lock device; and wherein after a command is inputted in the user interface or the electronic key, the PCBA receives the command and allows the moving mechanism to move that drives the locking tongue to retract and unlock the door.

The above objects and advantages are met by the present invention. In addition, the above and yet other objects and advantages of the present invention will become apparent from the hereinafter set forth. Brief Description of the Drawings, Detailed Description of the Invention and claims appended herewith. These features and other features are described and shown in the following drawings and detailed description.

### BRIEF DESCRIPTION OF THE DRAWINGS

So that those having ordinary skill in the art will have a better understanding of how to make and use the disclosed composition and methods, reference is made to the accompanying figures wherein:

FIG. 1 is a perspective view of an electronic locking device having a strike assembly and a lock body according to an embodiment of the present disclosure.

FIG. 2 is the device of FIG. 1 showing internal components of a lock body of one embodiment of the present disclosure in the unlocked position.

FIG. 3 is a lock body of one embodiment of the present disclosure using a mechanical expansion block and the electronic locking device in the locked position.

FIG. 4 is the lock body of FIG. 3 using a mechanical expansion block and the electronic locking device in the unlocked position.

FIG. 5 the lock body of FIG. 3 using a mechanical expansion block and the electronic locking device in the locked position.

FIG. 6 is the lock body of FIG. 3 using a mechanical expansion block and the electronic locking device in the unlocked position.

FIG. 7 is a lock body of one embodiment of the present disclosure using an electromagnetic power module and a blocking block with the electronic locking device in the locked position.

FIG. 8 is the lock body of FIG. 7 with the electronic locking device in the unlocked position.

FIGS. 9A and 9B are illustrations showing unlocking of the electronic locking device after receiving a signal from the electronic key and the cam moving horizontally.

FIGS. 10A and 10B are further illustrations showing unlocking of the electronic locking device after receiving a signal from the electronic key and the cam moving vertically.

FIG. 11 is one embodiment of a deadlock solution.

FIGS. 12A-12 D are the embodiment in FIG. 1 with the deadbolt engaged with the strike assembly.

FIG. 13 is an alternate embodiment of the embodiment in FIG. 11.

FIGS. 14A-14B are cross sectional views of the embodiment in FIG. 13 in the locked position.

FIGS. 15A-15B are cross sectional views of the embodiment in FIG. 13 in the unlocked position.

FIG. 16 is another alternate embodiment of the embodiment in FIG. 11.

FIGS. 17A-17C are cross sectional views of the embodiment in FIG. 16 in the locked position.

FIGS. 18A-18C are cross sectional views of the embodiment in FIG. 16 in the unlocked position.

FIG. 19 is another alternate embodiment of the embodiment in FIG. 11.

FIGS. 20A-20D are cross sectional views of the embodiment in FIG. 19 in the locked position.

FIGS. 21A-21C are cross sectional views of the embodiment in FIG. 19 in the unlocked position.

FIGS. 22A-22B are perspective views of one embodiment of the assembled locking device where FIG. 22A illustrates the locking position and FIG. 22B illustrates the unlocking position.

FIGS. 23A-23B are perspective views of another embodiment of the assembled locking device where FIG. 23A illustrates the locking position and FIG. 23B illustrates the unlocking position.

FIG. 24 is a perspective view of a wireless charging (either contact or non-contact) and moving mechanism embodiment of the assembled locking device where FIG. 24 illustrates the locking position.

FIG. 25 is a perspective view of a wireless charging (either contact or non-contact) and moving mechanism embodiment of the assembled locking device where FIG. 25 illustrates the unlocking position.

FIG. 26 is a perspective view of a wireless charging (either contact or non-contact) and moving mechanism embodiment of the assembled locking device having a conducting medium where FIG. 26 illustrates the locking position, and

FIGS. 27A and 27B are perspective views of a wireless charging (either contact or non-contact) and moving mechanism embodiment of the assembled locking device having a conducting medium where FIGS. 27A and 27B illustrate the unlocking position.

Reference numerals

1 Strike Assembly, 2 Lock Body, 3-Expansion Block, 4-Electric Module (power module), 5-Strike, 6-Locking Tongue, 7-Auxillary Latch (cam locking member), 8-Auxillary Latch Spring, 9-Positioning piece, 10-Cam, 11-Link Strip, 12-Electromagnetics Module (power module), 13-Blocking Block Spring, 14-Blocking Block (cam locking member), 15-hole/center of cam,16-plurality of protrusions, 17-groove in cam, 18-locking tongue mechanism, 19-Locking tongue body, 20-locking tongue spring, 21-locking tongue position piece, 22-locking tongue cap, 23-distal end of auxiliary latch, 24-distal end of blocking block, 25-proximal end of auxiliary latch, 26-proximal end of blocking block, 27-electronic key, 28-solution 1 strike assembly, 29-solution 1 deadbolt, 30-solution 2 strike assembly, 31-solution 2 deadbolt, 32-solution 3 strike assembly, 33-solution 3 deadbolt, 34-solution 4 strike assembly, 35-solution 4 deadbolt, 36-opening, 37-moving mechanism, 38-moving mechanism having PCBA, 39-conducing medium, 40-power source or power supply cable, 41-printed circuit board assembly (PCBA), 42-motor gearbox, 43-cam, 44-cam gear, 45-cover plate, 46-motor gearbox's gear, 47-energy receiving end, 48-energy transmission end with conducting medium, 49-energy receiving end with conducting medium, 50-energy transmission end, 51-blocking plate, 52-blocking plate spring, 53-limiting plate, 54-auxiliary latch protrusion, 55-limiting plate protrusion, 56-telescopic rod or locking tongue rod, 57-strike electrode, 58-deadbolt electrode, 59-locking tongue sleeve, 60-strike module, 61-first electrode or electrode (1), 62-second electrode or electrode (2), and 63-cam protrusion arm.

### DETAILED DESCRIPTION

The embodiments of the present disclosure are described in detail below. Examples of the embodiments are shown in the accompanying drawings, in which the same or similar reference numerals indicate the same or similar elements or elements with the same or similar functions. The embodiments described below with reference to the accompanying drawings are exemplary, and are only used to explain the present disclosure, but should not be understood as limiting the present disclosure.

In the description of the present disclosure, it should be understood that the orientation or positional relationship involved in the orientation description, such as up, down, front, back, left, right, proximal and distal are based on the orientation or positional relationship shown in the drawings, and it is only for the convenience of describing the present disclosure and simplifying the description, rather than indicating or implying that the device or element referred must have a specific orientation, be constructed and operated in a specific orientation, and therefore cannot be understood as a limitation of the present disclosure.

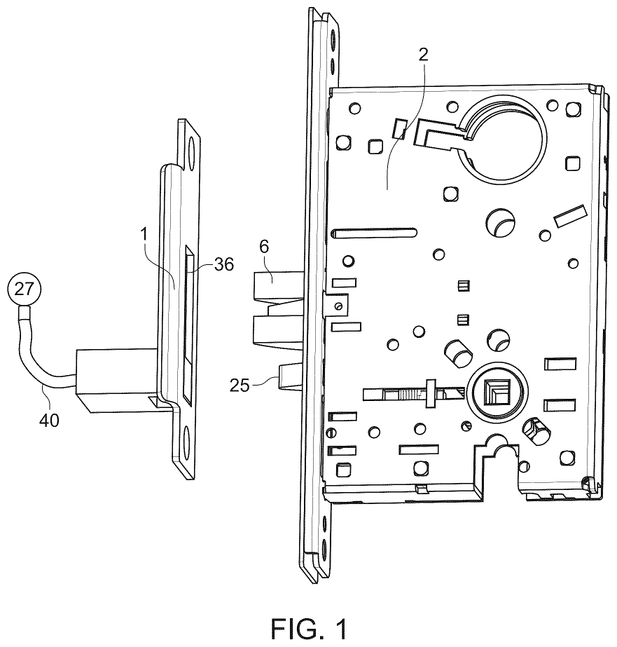

Referring to FIG. 1, illustrated is one embodiment of the present disclosure. Shown is an electronic locking device and lock that comprises a strike assembly 1 and a lock body 2. An electronic key 27 may be utilized to activate the electronic locking device. The electronic key may include, but is not limited to, for example a fingerprint, retina scan, biometric reading, wireless token, password, a user interface, and the like. A doorbell for example may be utilized as a user interface. Also there may be a keypad utilized that is not attached to the door. Similarly the system could be wireless and controlled solely by a mobile phone, tablet, or other personal device assistant.

The strike plate assembly 1 includes a strike plate having an opening and a power module. Depending on the embodiment, the power module may be an electric module or an electromagnetic module as discussed herein. The lock body 2 includes a locking tongue 6 and may also include an auxiliary latch. The locking tongue engages with an opening 36 in the strike plate to lock the door. The proximal portion 25 of the auxiliary latch may also assist in maintaining the door to lock. As shown in FIG. 1 and the accompanying figures all the electronic components, power, and/or wiring are located through the doorframe on the strike plate side of the doorframe for advantages previously discussed.

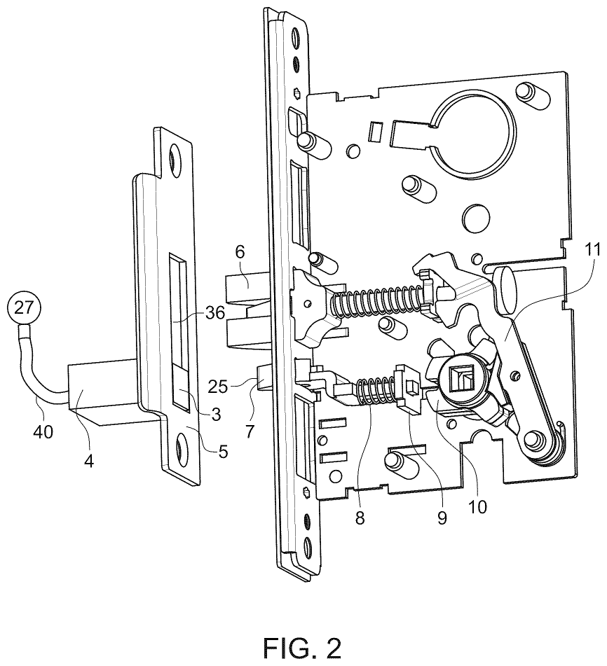

FIG. 2 illustrates the lock body 2 without its top cover to illustrate the mechanical components inside. FIG. 2 also illustrates one embodiment of the present disclosure. Shown in the strike assembly 2 is an electric module 4 and expansion block 3. The module 4 may include, but is not limited to, an electric motor, an electric magnet, a dashpot, an electromechanical piston, and the like. The module 4 includes the expansion block 3 that moves linearly back and forth as module 4 is activated and deactivated by the electronic key 27. The strike assembly also includes a strike plate 5 having an opening to receive the locking tongue 6 and the proximal end 25 of the auxiliary latch 7.

Depending on the embodiment, the lock body 2 may further include the auxiliary latch 7 having a proximal end 25 and a distal end 23. The auxiliary latch 7 further may include an auxiliary latch spring 8 secured in position by a positioning piece 9. The positioning piece 9 provides resistance to spring 8 such that the expanded spring 8 retracts the distal portion 23 away from a cam 10 to allow the cam to rotate. The spring 8 is expanded when expansion block 3 is retracted in the electric module 4.

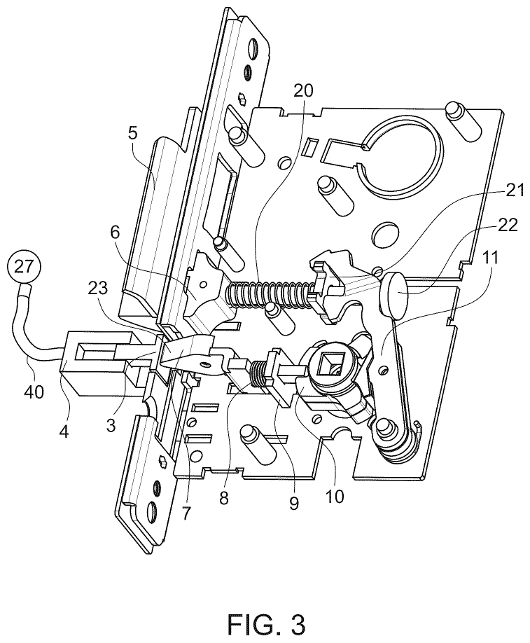

As shown in FIG. 3, when the expansion block 3 is expanded the spring 8 is compressed against positioning piece 9 and the distal portion 23 of the auxiliary latch is engaged in the cam 10 to stop the cam from rotating and therefore locking the door. A link strip 11 is in communication with the cam 10 to lock the locking tongue 6 in the opening of the strike plate 5 keeping the door locked.

The locking tongue 6 is part of a locking tongue body 19. A locking tongue spring 20 is disposed over the locking tongue body. A locking tongue positioning piece 21 provides resistance for the spring 20. When the spring 20 is expanded the locking tongue 6 is engaged in the opening 36 of the strike plate 5 and the door is locked. When the spring 5 is compressed the locking tongue is retracted and the door is allowed to open.

Depending on the embodiment the locking tongue body may also have a locking tongue cap 22. Locking cap 22 and locking tongue positioning piece 21 provide resistance to link 11 that may be disposed between them and allow the link 11 to move the locking tongue 6.

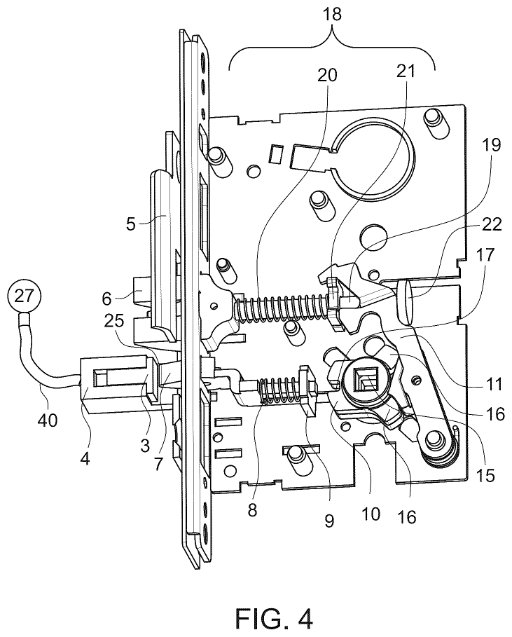

Adverting to FIG. 4, shown is the operation of one embodiment of the locking device utilizing the electric module 4 and expansion block 3. As shown spring 8 forces the auxiliary latch to push the expansion block 7 into the electric module 4. Movement of the expansion block to open the door is initiated by the electric key 27. After activation, the distal portion 23 of the auxiliary latch is retracted from a groove 17 of cam 10. Cam 10, depending on the implementation may have a plurality of protrusions 16 that rotate with the cam's rotation in a circular path that drives the link strip 11. The cam 10 may also include a hole 15 in the center of the cam to receive a doorknob shaft that will turn the cam when the cam is unlocked as shown in FIG. 4.

Further illustrated in FIG. 4, is locking tongue mechanism 18 that includes the locking tongue 6, the spring 20, the positioning piece 21 and the locking tongue cap 22. When the cam 10 is free to rotate because the distal portion 23 is retracted from groove 17, rotation of the cam drives the link strip 11 that retracts the locking tongue 6. Spring 20 keep the locking tongue in the hole of the strike plate until the cam is rotated making the turning forces of the cam overcome the strength of the spring to retract the locking tongue and open the door. Once the cam stops rotating and force is released from the doorknob shaft, the spring 20 moves the locking tongue back into the hole of the strike plate.

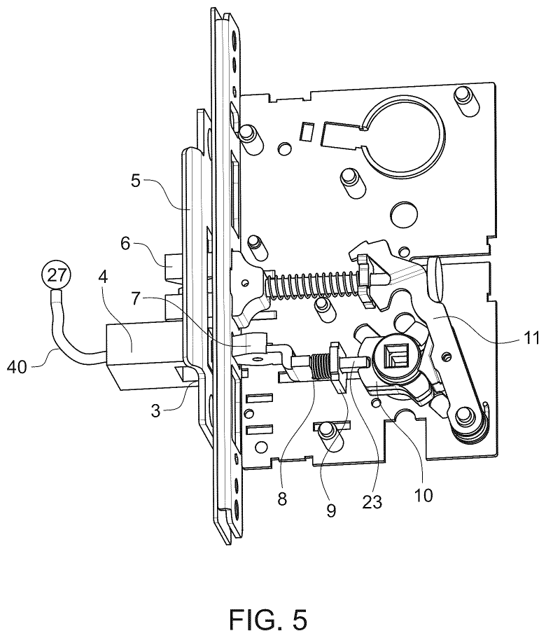

FIG. 5 illustrates the locking or closing feature of the electric module and expansion block embodiment. After the door is closed extension of the expansion block occurs. The auxiliary latch compresses the auxiliary latch spring. The auxiliary latch may have a bend such that the bend contacts the auxiliary latch spring on one end and the other end of the auxiliary spring contacts the positioning piece. The distal end of the auxiliary latch extends into the groove of the cam locking the cam. The locked cam prevents the cam from rotating and maintained the closed locked door.

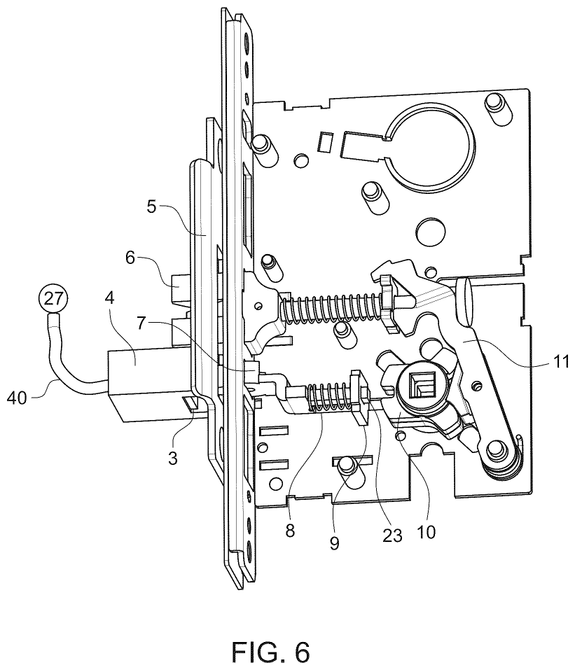

FIG. 6 illustrates further the unlocking principle of the electric module and auxiliary latch mechanical system. After inputting the electronic key, the electric module drives the expansion block to retract The auxiliary latch spring again fully extends the auxiliary latch. The distal end of the auxiliary latch detaches from the groove of the cam. The cam is the able to freely rotate that drives the slink strip to move. The link strip again drives the locking tongue to retract allowing opening and unlocking of the door.

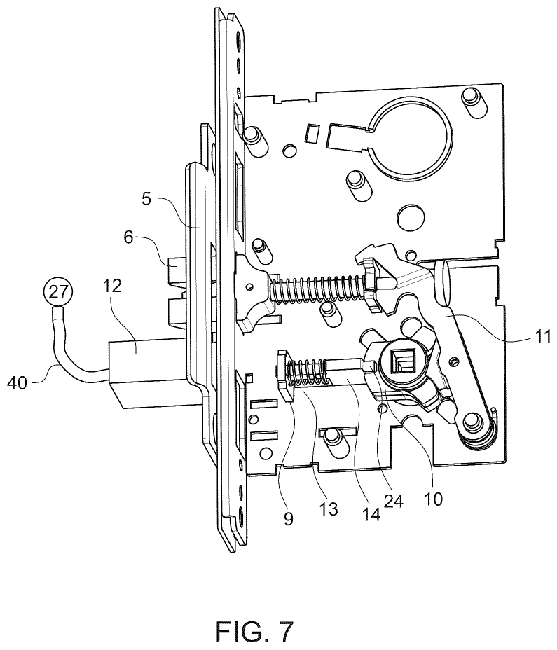

FIG. 7 illustrates another embodiment that utilizes an electromagnetic module 12 and a blocking block 14. Depending on the implementation, the blocking block may have a spring 13 disposed over it and in contact with positioning place 9. Extension of the spring 13 drives a distal portion 24 of the blocking block to engage with the groove of the cam 10 locking the cam and not allowing the cam to rotate, therefore locking the door. After the door is closed the distal end 24 of the blocking block extends into the cam's groove locking the cam and maintaining the closed lock.

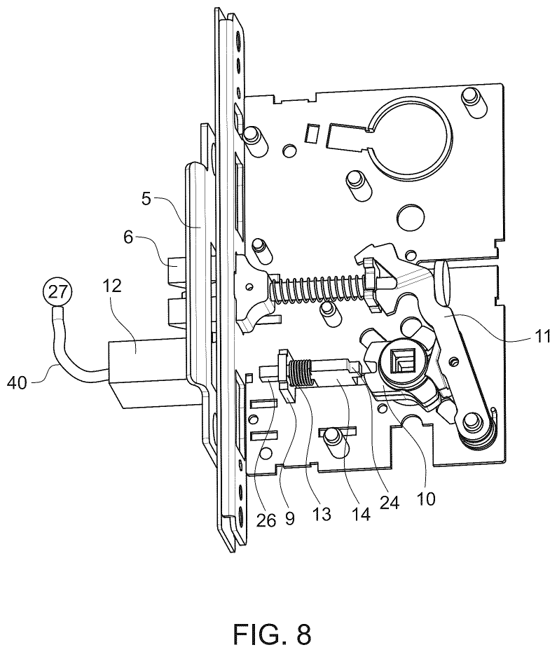

FIG. 8 illustrates the unlocking of the locking device in the embodiment in FIG. 7. After inputting the electronic key the electromagnetic module generates a magnetic field the proximal end 26 of the blocking block is pulled toward the electromagnetic module 12. The distal end 24 disengages from the groove of the cam. This disengagement allows the cam to freely rotate when the doorknob shaft is turned.

The cam's rotation drives the link strip to move and the link strip then drives the locking tongue to retract from the opening of the strike plate to unlock the door.

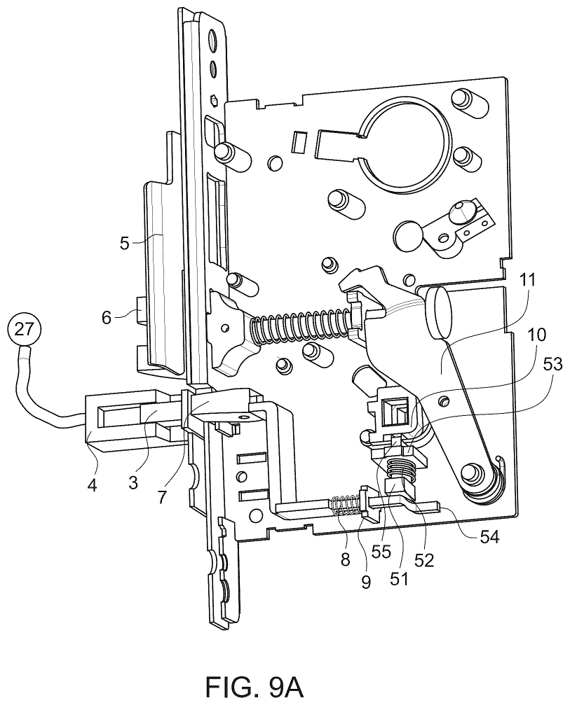

FIG. 9A and FIG. 9B illustrate the electronic locking device unlocking after receiving a signal from the electronic key. And the cam moving horizontally. Depending on the embodiment the cam may move in any direction and in any manner. After receiving a signal from the electronic key 27, such as but not limited a fingerprint, password and the like the electric module 4 retracts the expansion block 3 and the auxiliary latch spring 8 fully extends. An auxiliary latch protrusion 54 is detached from a blocking plate 51 and a blocking plate spring 52 causes the blocking plate 51 to detach from the groove of the cam. A limiting plate 53 is used to guide a limiting plate protrusion 55 that is part of the blocking plate 51 into the grove of the cam. The limiting plate also provides resistance to the blocking plate spring and limits the travel of the limiting plate protrusion into the groove of the cam. The cam can horizontally move or move in any direction depending on the embodiment by action of the doorknob and push the link strip 11 forcing the link strip to pull the locking tongue 6 into the locking device to unlock the door.

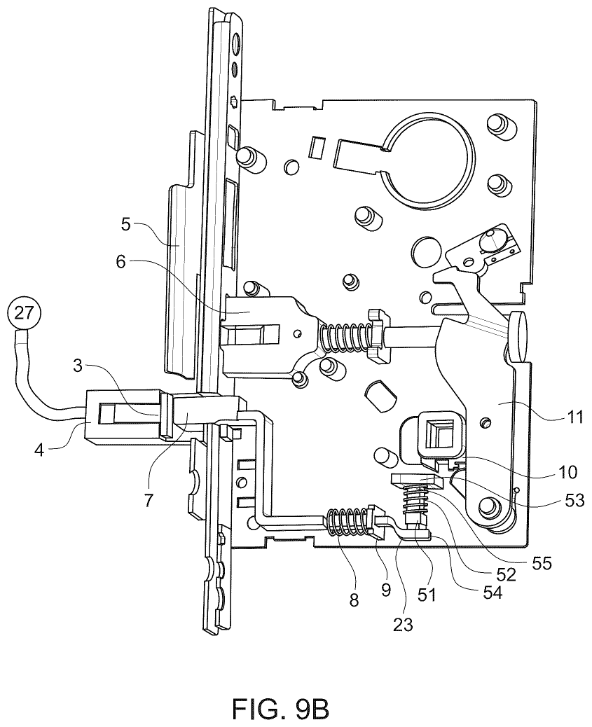

FIG. 10A and FIG. 10B illustrate the electronic locking device unlocking after receiving a signal from the electronic key 27. The electric module 4 or the electromagnetics module 12 retracts the expansion block and the auxiliary latch spring fully extends the auxiliary latch. The auxiliary latch detaches from the groove of the cam. The cam can move vertically by action from the doorknob and push the link strip. The link strip then pulls the locking tongue into the lock to unlock the door.

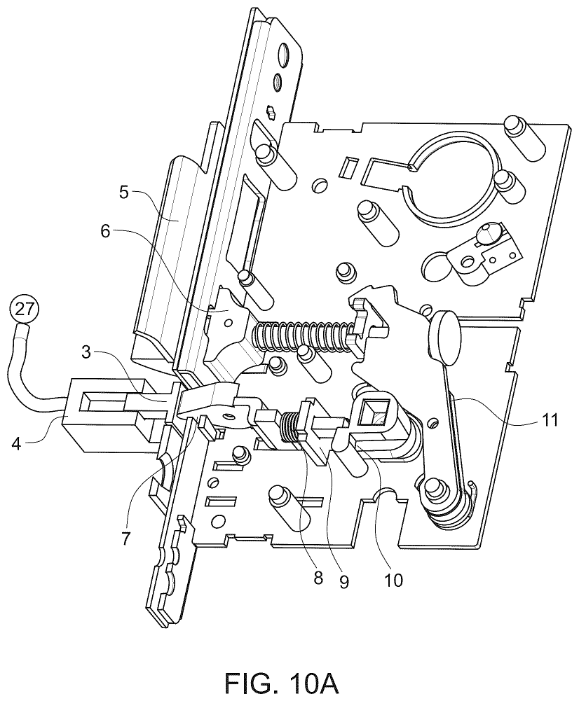

FIG. 11 is an embodiment of a deadbolt lock solution. Shown in FIG. 11 is a disassembled view of solution 1 strike assembly 28 and solution 1 deadbolt 29. An opening 36 is disposed in strike assembly 28 that has a strike.

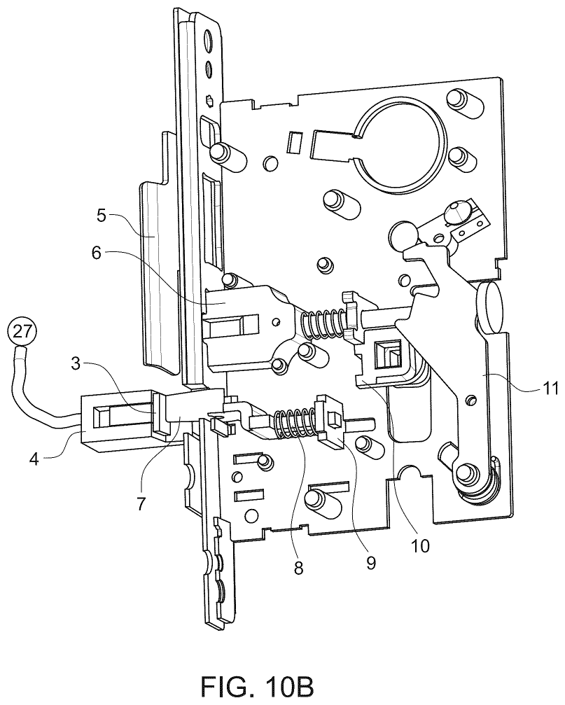

FIGS. 12A-12D illustrate a cross-sectional view of the deadbolt lock shown in FIG. 11. FIG. 12A and FIG. 12B are enlargements of sections in FIG. 12C and FIG. 12D, respectively. The solution 1 strike assembly 28 and deadbolt 29 in FIGS. 12A-12D comprises a locking tongue 6, a strike 5, an electromagnetics module 14, a positioning piece 9, a blocking block spring 13, a blocking block 14, and a cam 10. For the locking position, after the door is closed the tail end of the blocking block extends into the groove of the cam for preventing the cam from moving and maintaining the closed lock. To unlock the deadbolt, after inputting the electronic key such as a fingerprint, password and the like, the electromagnetic module generates a magnetic force to move the blocking block to detach from the groove of the cam. The cam is then fee to move. A user can move the cam by the door handle and the cam drives the locking tongue to retract and then the door is unlocked.

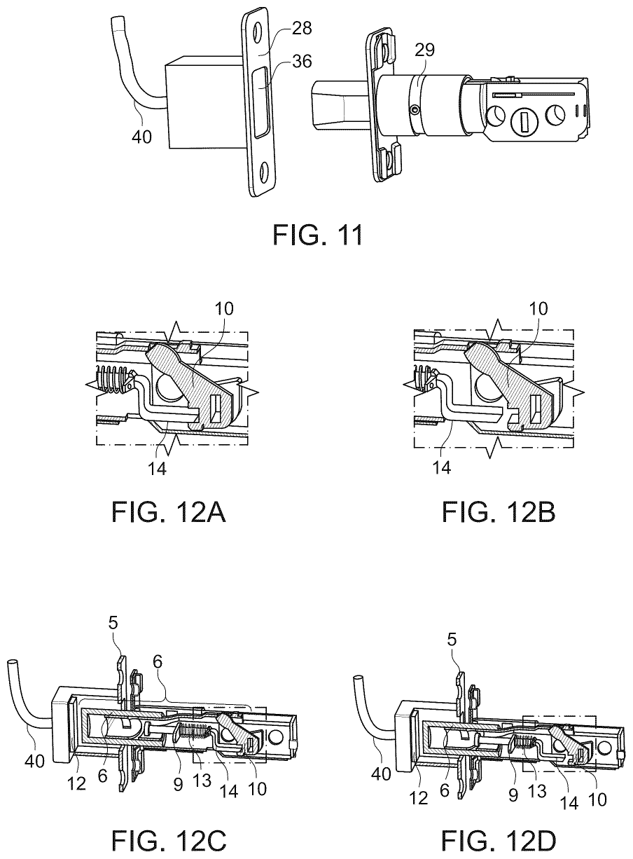

FIG. 13 illustrates a solution 2 or different embodiment to the embodiment shown in FIG. 11. Shown is a strike assembly 30 for solution 2 and a deadbolt 31 for solution 2. An opening 36 is disposed in strike assembly 30 that has a strike.

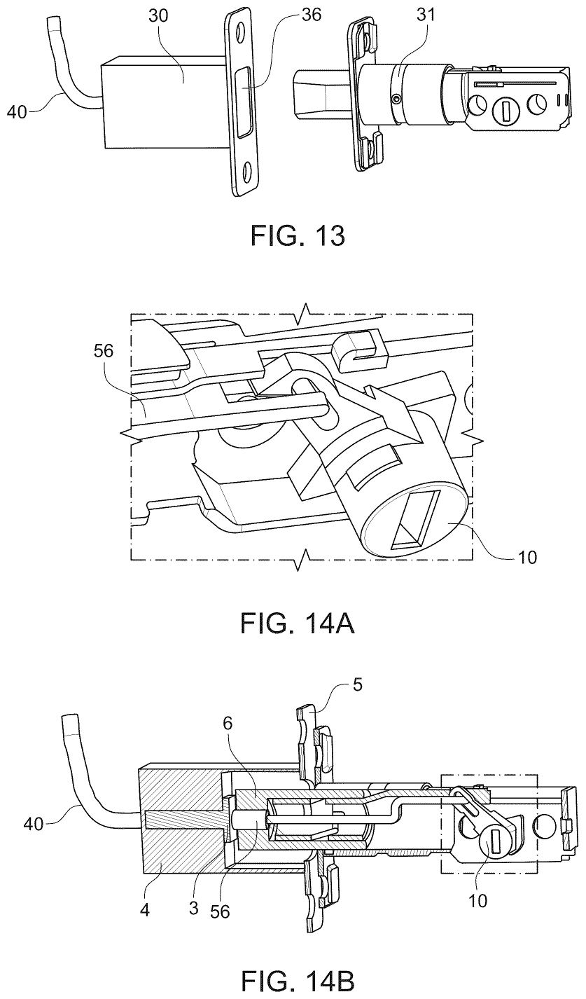

FIGS. 14A-14B illustrate the locking position for the embodiment shown in FIG. 13. FIG. 14A is an enlarged view of a section in FIG. 14B. Shown is a cross-sectional view of strike assembly 30 and deadbolt 31 that comprise an electric module 4, a locking tongue 6, an expansion block 3, a telescopic rod 56, a strike 5, and a cam 10. To lock this system shown, after moving the door handle, the handle moves the cam and then the cam moves the locking tongue to extend and lock the door.

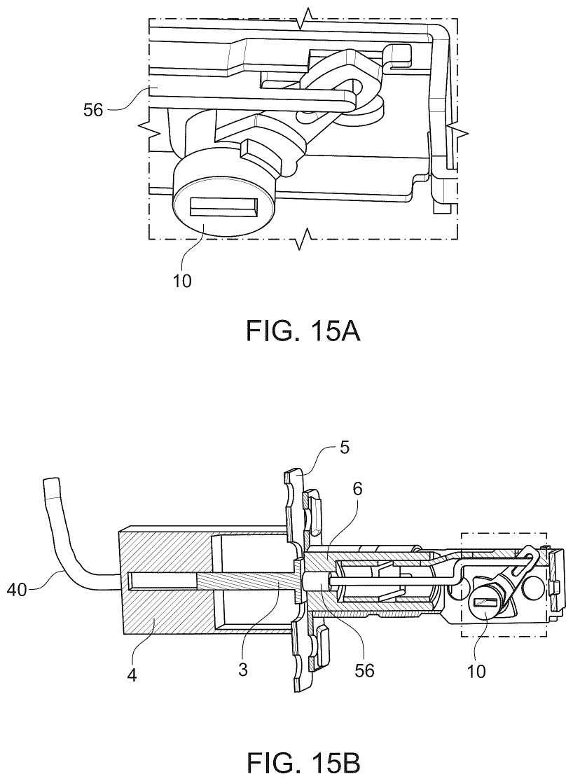

FIGS. 15A-15B illustrate the unlocking position for the embodiment shown in FIG. 13 solution 2. FIG. 15A is an enlarged view of a section in FIG. 15B. After inputting the electronic key as previously described, the electric module drives the expansion block to extend, and the expansion block drives the telescopic rod to move and the telescopic rod drives the cam to move. The cam drives the locking tongue to retract and then the door is unlocked.

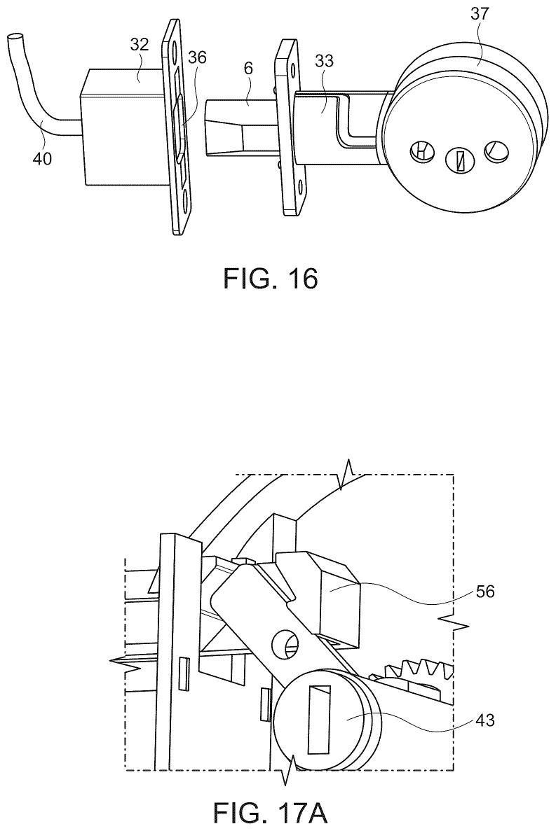

FIG. 16 illustrates a solution 3 or different embodiment to the embodiment shown in FIG. 11. Shown is a strike assembly 32 for solution 3 and a deadbolt 33 for solution 3. Strike assembly 32 has an opening 36 for receiving locking tongue 6. Locking tongue 6 moves by moving mechanism 37 further described herein.

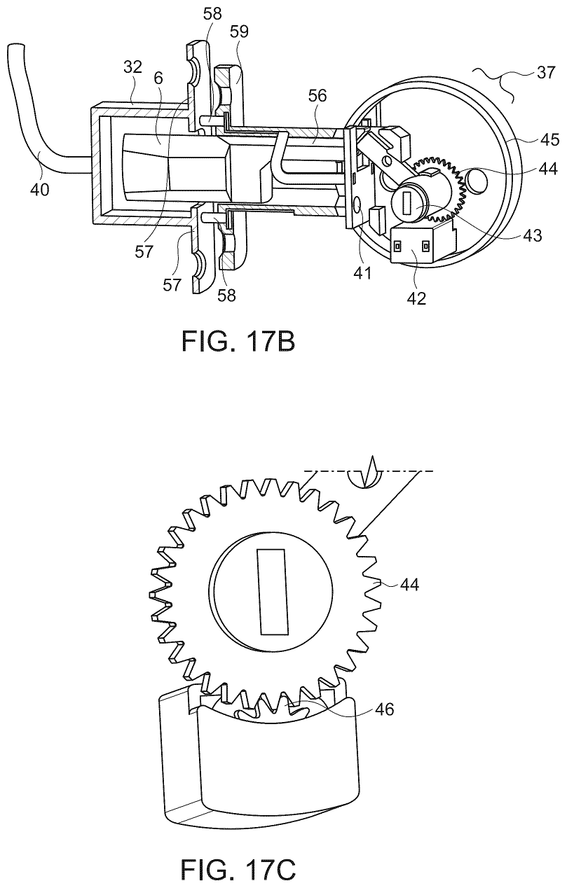

FIGS. 17A-17C illustrate the locking position for the embodiment shown in FIG. 16. FIG. 17A and FIG. 17C are enlarged views of sections of FIG. 17B. Shown in FIG. 17B is a cross-sectional view of strike assembly 32 and deadbolt 33 that comprise the power supply cable 40, a strike assembly 32, a strike module 60, a locking tongue 6, a deadbolt electrode 58, a locking tongue sleeve 59, a printed circuit board assembly (PCBA) 41 that may or may not be in the moving mechanism, a motor gearbox 42, a cam 43, a cam gear 44, a cover plate 45, and motor gearbox's gear 46. To lock this system shown, after the door is closed, the power supply cable delivers electricity to a strike electrode 57. The strike electrode 57 may be the strike itself or it may have electrodes incorporated into the strike. The strike electrode supplies power to the deadbolt electrode 58. The deadbolt electrode then supplies power to the PCBA 41. The PCBA supplies power to the motor gearbox 42.

In locking the above system in solution 3, after inputting the lock closing command into a user interface, which includes but is not limited to a mobile device, a keypad, a biometric interface, and any combination thereof, the PCBA receives the information and allows the motor gearbox gear to drive the cam gear to move. The cam gear rotates and drives the locking tongue rod to move. The locking tongue rod drives the locking tongue to extend and then the door is locked.

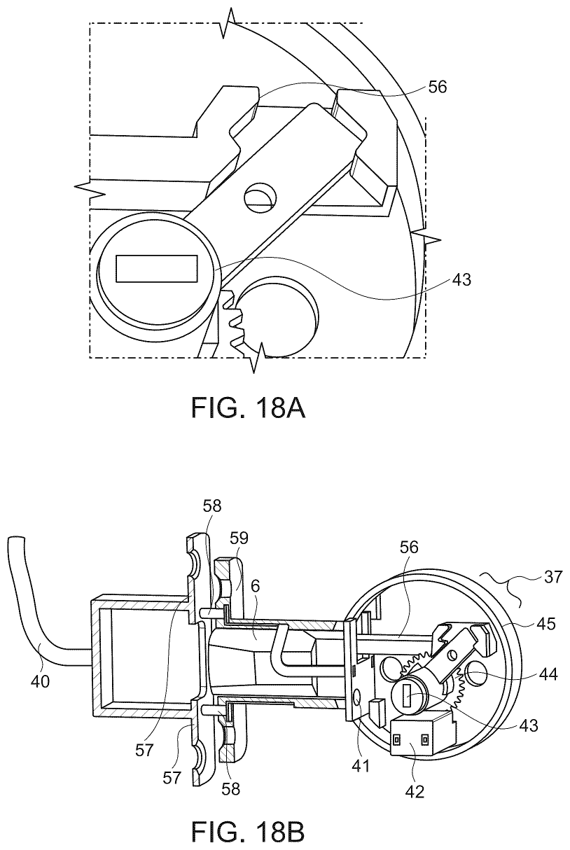

FIGS. 18A-18C illustrate the unlocking position for the embodiment shown in FIG. 16 solution 3. FIGS. 18A and 18C are enlarged views of sections in FIG. 18B. After inputting the unlocking command, or an electronic key as previously described, the PCBA receives the information and allows the motor gearbox gear to drive the cam's gear to move. The cam gear drives the locking tongue rod to move and the locking tongue rod drives the locking tongue to retraction and then the door is unlocked.

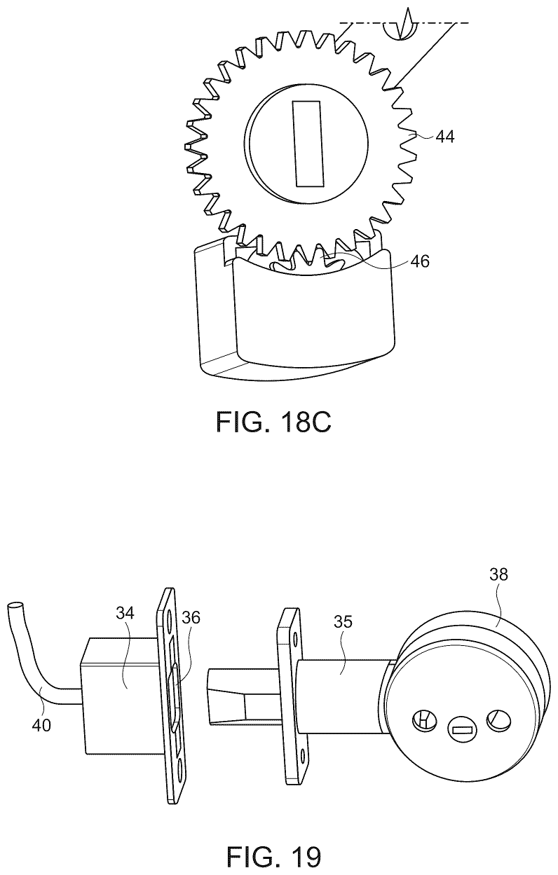

FIG. 19 illustrates a solution 4 or different embodiment to the embodiment shown in FIG. 11. Shown is a strike assembly 34 for solution 4 and a deadbolt 35 for solution 4 with moving mechanism 38 described further herein.

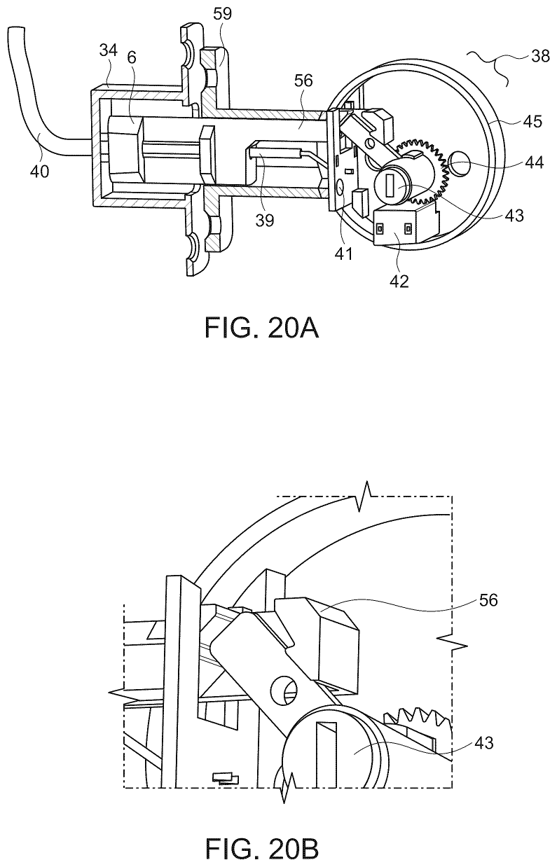

FIGS. 20A-20D illustrate the locking position for the embodiment shown in FIG. 19. FIGS. 20B, 20C, and 20D are enlarged views of sections in FIG. 20A. Shown is a cross-sectional view of strike assembly 34 and deadbolt 35 that comprise an electrode (1) or first electrode 61 and an electrode (2) or second electrode 62, a power supply cable 40, a strike assembly 34, a locking tongue6, a cable or a conducting medium 39, wherein the conducting medium may be any means of conducting electric power including but not limited to wireless, radio frequency, conducting material and the like, a PCBA 41, a motor gearbox 42, a cam 43, a cam gear 44, a cover plate 45, a locking tongue sleeve 59, and a motor gearbox's gear 46. After the door is closed the power supply cable delivers electricity to electrode 1 and electrode 1 supplies electricity to electrode 2. Electrode 2 supplies electricity to the PCBA through the cable or conducting medium 39. The conducting medium includes but is not limited to an electrical cable, a wire, a conductive material, and the like. The PCBA has a capacitor that can store electricity for the motor to move the motor gearbox then the deadbolt lock can lock and unlock. To lock this system shown, after giving the lock closing command or electronic key, the PCBA receives the information and allows the motor gearbox's gear to drive the cam gear to move. The cam gear drives the cam to move and the cam drives the locking tongue to extend, and lock the door.

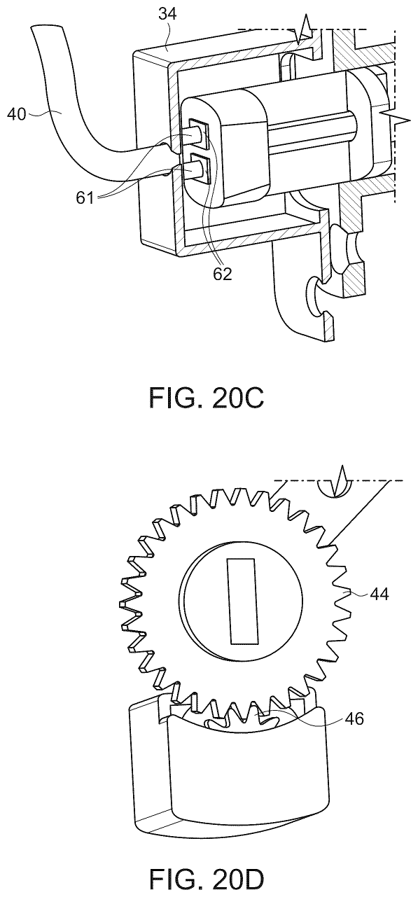

FIGS. 21A-21C illustrate the unlocking position for the embodiment shown in FIG. 19 solution 4. FIGS. 21A and 21C are enlarged views of sections in FIG. 21B. After giving the unlocking command or using the electronic key, the PCBA 41 receives the information and allows the motor gearbox's gear 46 to reverse drive and reverse move the cam gear 44. The cam gear drives the cam to move, and drives the locking tongue 6 to retract, and then the door is unlocked. Depending on the embodiment when the cam moves a cam protrusion arm moves that moves the locking tongue rod 56 that moves the locking tongue 6.

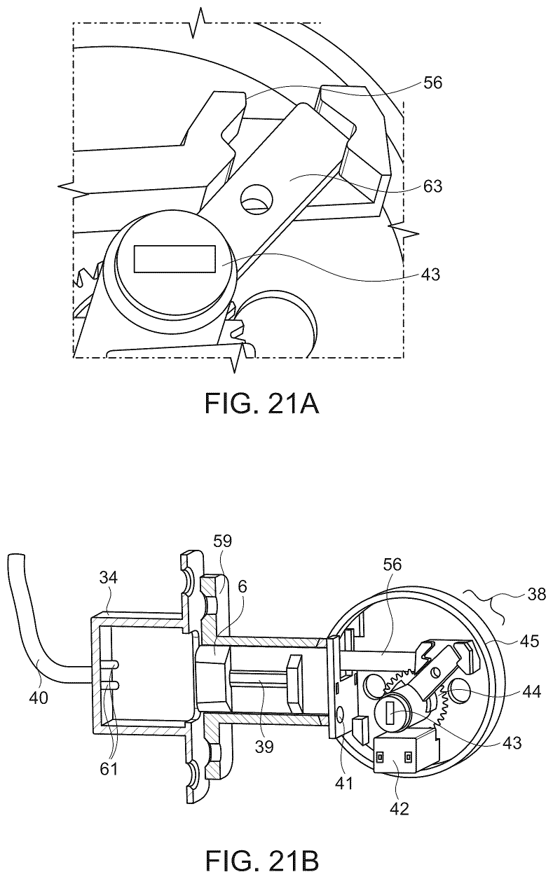

FIGS. 22A-22B are perspective views of one embodiment of the assembled locking device where FIG. 22A illustrates the locking position and FIG. 22B illustrates the unlocking position. Illustrated in FIGS. 22A-22B is moving mechanism 37. Moving mechanism 37, depending on the implementation may include one or more of the following components conducting medium 39, PCBA 41, Motor gearbox 42, cam 43, cam gear 44, and cover plate 45. Such an embodiment is shown in for example, but not limited to, FIG. 16, FIGS. 17A-17C and FIGS. 18A-18C.

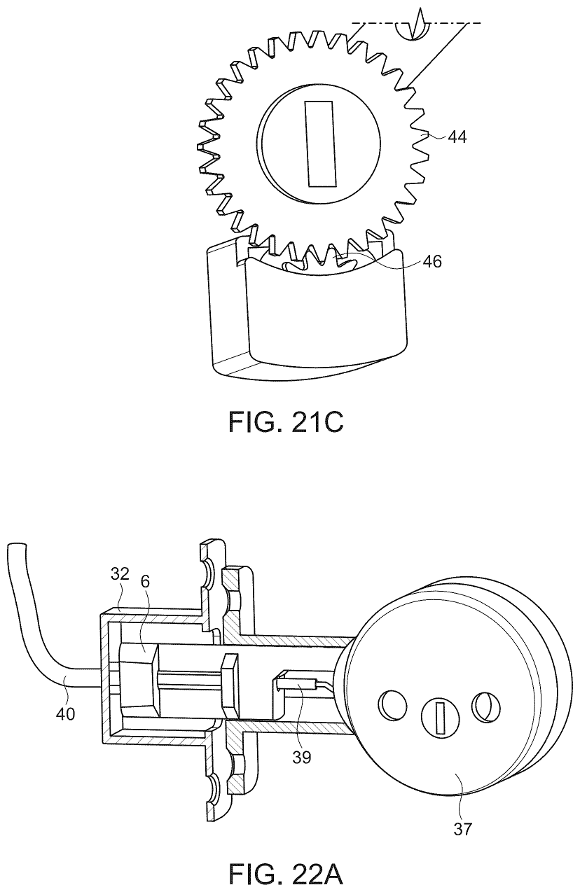

FIGS. 23A-23B are perspective views of another embodiment of the assembled locking device where FIG. 23A illustrates the locking position and FIG. 23B illustrates the unlocking position. Illustrated in FIGS. 22A-22B is moving mechanism 37. Moving mechanism 38, depending on the implementation may include one or more of the following components PCBA 41, Motor gearbox 42, cam 43, cam gear 44, and cover plate 45 and a conducting medium 39 connecting to PCBA 41, strike electrode 60, and deadbolt electrode 58. Such an embodiment is shown in for example, but not limited to, FIG. 16, FIGS. 17A-17C and FIGS. 18A-18C, FIG. 19, FIGS. 20A-20C and FIGS. 21A-21C.

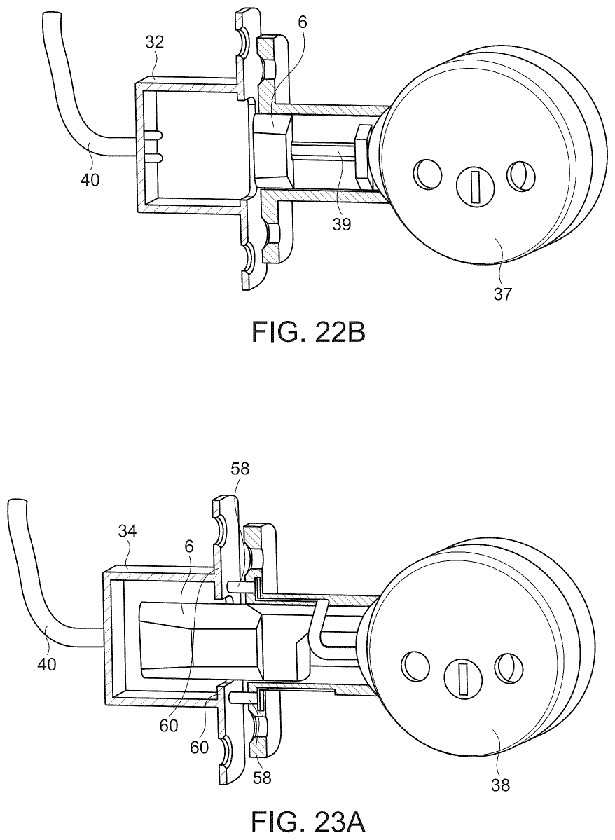

FIGS. 24-27B all use the inventive subject matter previously described herein with the addition of utilizing wireless charging to lock and unlock the door. The wireless charging may be contact based or non-contact based depending on the embodiment. The power supply may be either a house alternating current or a direct current such as a battery. Depending on the embodiment no external power supply may be needed and the lock device has electric storage capacity to be charged wirelessly when electric storage capacity is low. Furthermore there may be a user interface that allows the user to determine when the electric storage capacity is low. This interface includes, but is not limited to, a phone app, an electrical display on the locking device, and any combination thereof.

Wireless charging uses electromagnetic induction, also known as inductive coupling, to transfer energy between two objects, such as a charger and a smartphone. The charging base has a transmitter coil that sends out a signal, and the signal searches for a receiver coil, like the one in a compatible smartphone. When the signal senses a receiver coil, the transmitter coil's electrons start to flow around. The transmitter coil emits an alternating magnetic field, which induces an alternating voltage/current in the receiver coil inside the device. Wireless charging may be accomplished with or without contact. With contact means that a transmission end and receiving end have physical contact. Without contact means that the transmission end and the receiving end are not in physical contact and the energy is transmitted by radio frequency, microwaves, electromagnetic forces and other energy wireless transmission forms or combinations thereof, and the like.

In the present embodiment as shown in FIG. 24 a wireless charging, either contact wireless charging or non-contact wireless charging, and moving mechanism embodiment of the assembled locking device is shown in the locking position. In the locking position Locking tongue of locking body 19 is shown entering strike assembly 1. Power from power supply cable 40 transmits electrical power to energy transmission end 50. The energy transmission end 50 then transmits energy either by contact or noncontact with energy receiving end 47. Energy receiving end 47 sends power to the moving mechanism 37 to lock and unlock or move the locking tongue and locking body. Furthermore, depending on the embodiment, the wireless charging may include for the strike assembly a power source for delivering electricity to the strike electrode or the energy transmission end 50. The strike electrode or the energy transmission end then may have an opening on one side of the door frame for the locking tongue to move therein. The deadbolt assembly further may include the deadbolt electrode or the energy receiving end 47, the moving mechanism, and the locking tongue. After the door is closed the power source delivers electricity to the strike electrode or the energy transmission end that powers the deadbolt electrode or the energy receiving end that supplies power to the moving mechanism locking and unlocking the door.

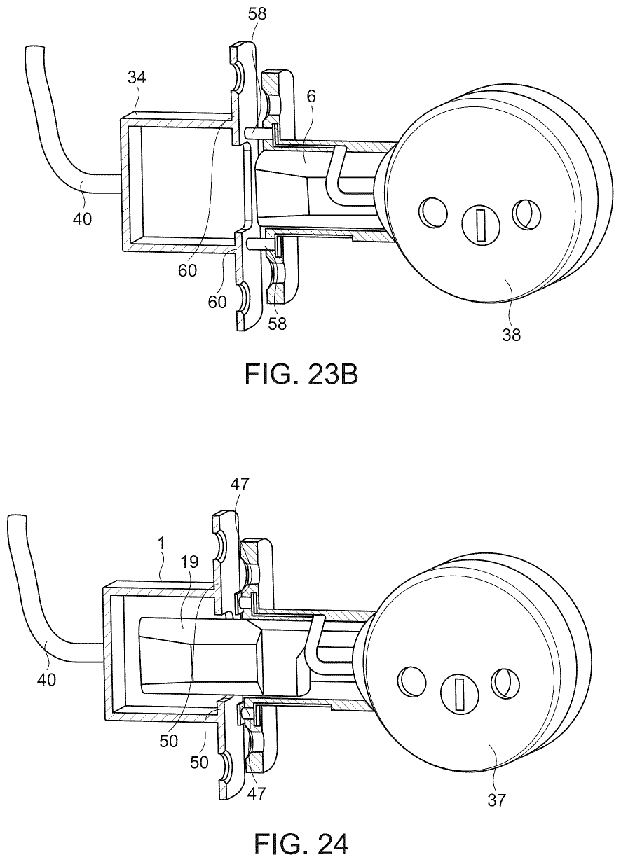

FIG. 25 is a perspective view of a wireless charging (either contact or non-contact) and moving mechanism embodiment of the assembled locking device of FIG. 24 but in the unlocking position. Again the power is transmitted wither by contact or non-contact, such as but not limited to Radio frequency, microwave, electromagnetic forces and the like, of the energy transmission end and energy receiving end. Alternatively, the locking device may be charged either contact or non-contact directly without the power supply cable where power is stored in the locking device itself.

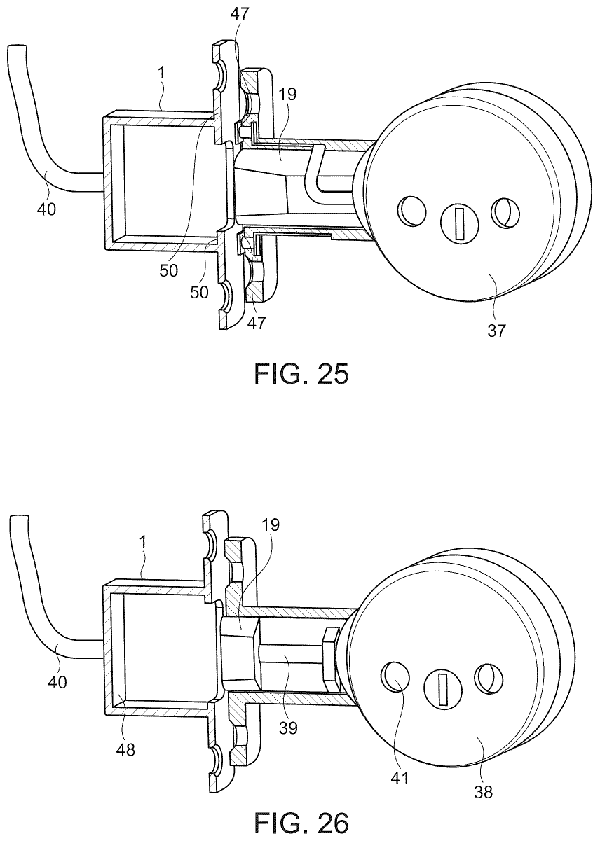

FIG. 26 is a perspective view of a wireless charging again either contact or non-contact wireless charging as previously described, but with a moving mechanism 38 having a PCBA 41 and a conducting medium 39. This embodiment of the assembled locking device in FIG. 26 illustrates the locking position.

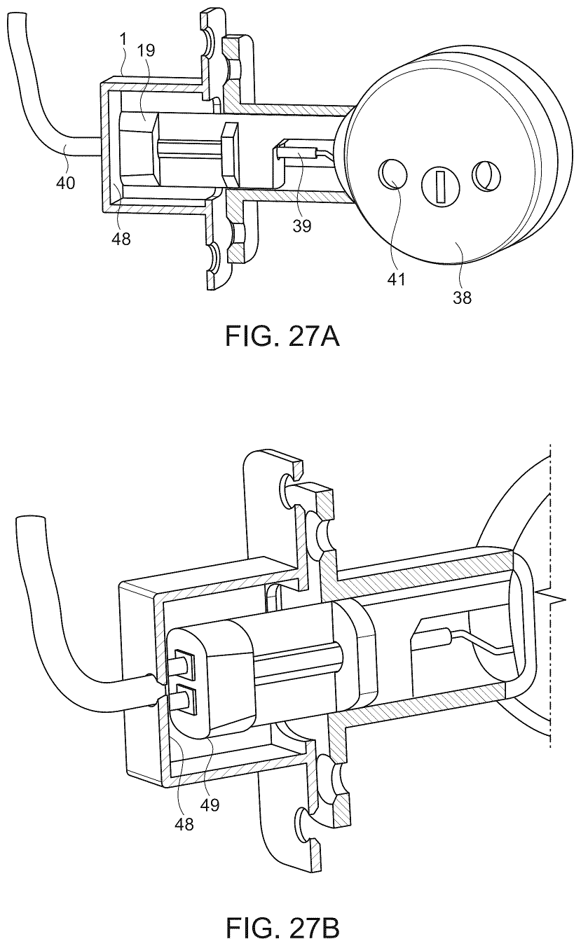

In the present embodiment as shown in FIGS. 26-27B a wireless charging, either contact wireless charging or non-contact wireless charging, and moving mechanism embodiment of the assembled locking device is shown in the locking position. In the locking position Locking tongue of locking body 19 is shown entering strike assembly 1. Power from power supply cable 40 transmits electrical power to energy transmission end 48. The energy transmission end 48 then transmits energy either by contact or noncontact with energy receiving end 49. Depending on the implementation there may or may not be a conducting medium connected to the moving mechanism for transmitting power to the moving mechanism.

Energy receiving end 49 sends power to the moving mechanism 38 having a PCBA 41 to lock and unlock or move the locking tongue and locking body. Furthermore, depending on the embodiment, the wireless charging may include for the strike assembly a power source for delivering electricity to the strike electrode or the energy transmission end 48. The strike electrode or the energy transmission end 48 then may have an opening on one side of the door frame for the locking tongue to move therein. The deadbolt assembly further may include the deadbolt electrode or the energy receiving end 49, the moving mechanism 38, and the locking tongue. After the door is closed the power source delivers electricity to the strike electrode or the energy transmission end that powers the deadbolt electrode or the energy receiving end that supplies power to the moving mechanism locking and unlocking the door.

FIG. 27A and 27B are perspective views of a wireless charging (either contact or non-contact) and moving mechanism embodiment of the assembled locking device in FIG. 26 where FIGS. 27A and 27B illustrate the unlocking position. As shown in FIG. 26, FIGS. 27A-27B an energy transmission end 48 sends power to an energy receiving end 49. This may be do either with or without contact of the respective ends as previously described in FIGS. 24-25. Similar to FIGS. 24-25, the lock device itself may be wirelessly charged with or without contact by have an internal power storage (not shown) or stored in a capacitor of the PCBA 41 or the like.

The embodiments of the present disclosure are described in detail above with reference to the accompanying drawings, but the present disclosure is not limited to the above-mentioned embodiments. Within the scope of knowledge possessed by a person of ordinary skill in the technical field, various changes can also be made without departing from the purpose of the present disclosure.

While in the foregoing specification the present invention has been described in relation to certain embodiments thereof, and many details have been put forth for the purposes of illustration, it will be apparent to those skilled in the art that the invention is susceptible to additional embodiments and that certain of the details described herein can be varied considerably without departing from the basic principles of the invention.

The present invention may be embodied in other specific forms without departing from the spirit or essential attributes thereof, and, accordingly, reference should be made to the appended claims, rather than to the foregoing specification, as indicating the scope of the invention.

Although the invention herein has been described with reference to embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. An electric door lock device, comprising:
a strike assembly and a lock body;
the strike assembly including a power module for operatively performing as either an electric module or an electromagnetic power module;
the lock body including:
a cam capable of moving; a center of the cam defining a hole for a doorknob shaft to enter therethrough; the cam further defining a groove;
a cam locking member disposed between the power module and the cam for engaging with the groove in the cam;
a link strip in contact with the cam, wherein movement of the linked strap is controlled by movement of the cam;
a locking tongue mechanism controlled by movement of the link strip, the locking tongue mechanism including a locking tongue body having a locking tongue and a locking tongue spring disposed on the body; the locking tongue body being in contact with the link strip; and the locking tongue capable of retracting and extending into a doorframe strike plate of the strike assembly;
wherein, when a door in the doorframe is closed the locking tongue is extended into the doorframe strike plate and the cam locking member moves towards the cam and engages the groove for locking the cam and preventing the cam from moving and maintaining the door locked.

2. The device of claim 1, wherein the cam locking member further comprises a proximal end facing the power module and a distal end facing the cam; and wherein the distal end engages into the groove of the cam.

3. The device of claim 2, further comprising an electronic key that controls the power module; wherein when the electronic key is inputted the power module causes the distal end of the cam locking member to detach from the groove of the cam allowing the cam to move; and wherein movement of the cam by the doorknob shaft drives the link strip to move, and wherein the link strip drives the lock tongue to retract from the striking plate for unlocking the door.

4. The device of claim 3, wherein the cam locking member is an auxiliary latch or a blocking block.

5. The device of claim 4, wherein the power module is an electric module for the auxiliary latch, or an electromagnetic module for the blocking block.

6. The device of claim 5, wherein the electric module further comprises a block controlled by the electric module; the block capable of motion in a linear distal direction and a linear proximal direction relative to the power module.

7. The device of claim 6, wherein the block is an expansion block disposed inside the electric module and in contact with a proximal end of the auxiliary latch; wherein when the door is closed the expansion block is extended for moving the auxiliary latch to engage a distal end of the auxiliary latch into the groove of the cam for locking the cam and preventing the cam from moving and maintaining the door locked; and wherein after input of the electronic key, the expansion block is retracted into the electric module and the distal end of the auxiliary latch detaches from the groove of the cam allowing the cam to move and drive the link strip to retract the locking tongue from the strike plate allowing the door to open.

8. The device of claim 5, wherein the blocking block is disposed outside the electromagnetic module; wherein when the door is closed a distal end of the blocking block extends into the groove of the cam for locking the cam and preventing the cam from moving and maintaining the door locked; and wherein after input of the electronic key, the electromagnetic module generate a magnetic field to move a proximal end of the blocking block closer to the electromagnetic module and the distal end of the blocking block is detached form the groove of the cam allowing the cam to rotate and drive the link strip to retract the locking tongue from the strike plate allowing the door to open.

9. The device of claim 1, wherein the locking tongue mechanism further includes a locking tongue spring, a locking tongue positioning plate, and a locking tongue cap; wherein the locking tongue spring is in contact with the locking tongue positioning plate, and the link strip is positioned between the locking tongue positioning plate and the locking tongue cap for controlled movement of the locking tongue.

10. The device of claim 1, wherein the cam locking member further includes a spring and a positioning piece, wherein where the cam locking member is an auxiliary latch the spring is positioned closer to the power module and when the spring is extended the cam is allowed to move; and wherein where the cam locking member is a blocking block the spring is positioned closer to the cam and when the spring is extended the cam is an unable to move.

11. An electric door lock device, comprising:
an electric module or an electromagnetic module;
a cam capable of moving about a center of the cam, the cam receiving a doorknob shaft to enter therethrough;
a cam locking member disposed between the module and the cam for engaging with the cam;
a locking tongue mechanism controlled by movement of the cam, and
wherein, when a door in the doorframe is closed a locking tongue is extended into a doorframe strike plate and the cam is prevented from moving and maintaining the door locked.

12. The device of claim 11, further comprising
a plurality of protrusions thereabout the cam that move in a directional path when the cam is rotated, and move horizontally, or move vertically; and
a link strip in contact with the plurality of protrusions, wherein movement of the linked strap is controlled by movement of the plurality of protrusions of the cam and the link strip drives the locking tongue mechanism.

13. The device of claim 11, wherein the locking tongue mechanism further comprises a locking tongue body having the locking tongue and a locking tongue spring disposed on the body; the locking tongue body being in contact with the link strip; and the locking tongue capable of retracting and extending into a doorframe strike plate.

14. The device of claim 11, further comprising an electronic key for opening the door, wherein the cam locking member is retracted from a groove of the cam and the cam is allowed to rotate and retract the locking tongue from the doorframe strike plate to unlock the door.

15. The device of claim 14 wherein the cam locking member is either an auxiliary latch member driven by an expansion block and the power module is an electric power module; or the cam locking member is a blocking block driven by electromagnetic forces and the power module is an electromagnetic power module.

16. An electric door lock device, comprising
a power module for driving either an expansion block in contact with an auxiliary latch, or only a blocking block;
a cam for receiving a doorknob shaft, the cam further defining a groove wherein either a distal end of the auxiliary latch engages the groove or a distal end of the blocking block engages the groove to lock the cam and door; and
wherein when an electronic key is inputted either the auxiliary latch or the blocking block are released from the groove of the cam allowing the cam to rotate, move horizontally, or move vertically, and release a locking tongue for the door to open.

17. The device of claim 16, further comprising a linking strip, wherein when the cam is allowed to rotate the cam moves the link strip that releases a locking tongue for the door to open.

18. The device of claim 17, wherein the cam further includes protrusions and the protrusions drive the linking strip when the cam is rotated.

19. The device of claim 17, wherein the linking strip is an integral part of the locking tongue.

20. The device of claim 17, wherein the locking tongue is part of a locking tongue mechanism that includes a locking tongue body, a locking tongue spring disposed thereon, a locking tongue positioning piece in contact with the spring and a locking tongue cap, and wherein the linking strip is positioned between the cap and the positioning piece to move the locking tongue.

21. The device of claim 1, wherein the cam is capable of rotating about a center of the cam; the center of the cam defining a hole for a doorknob shaft to enter therethrough; and the plurality of protrusions move in a circular directional path when the cam is rotated.

22. The device of claim 1, wherein the cam is capable of moving either horizontally or vertically.

23. An electric door lock device, comprising:
a strike assembly and a deadbolt assembly;
the strike assembly including a power source for operatively activating either an electric module or an electromagnetics module; and
a doorframe strike plate;
the deadbolt assembly including:
a cam capable of moving; a center of the cam defining a hole for a doorknob shaft of a doorknob to enter therethrough; the cam further defining a groove;
a cam locking member disposed between the electric module or the electromagnetics module and the cam for engaging with the groove in the cam;
a locking tongue mechanism controlled by movement of the cam, the locking tongue mechanism including a locking tongue body capable of retracting and extending;
wherein, when a door in the doorframe is closed the locking tongue is extended into the doorframe strike plate and the cam locking member moves towards the cam and engages the groove for locking the cam and unlocking the door.

24. The electric door lock device of claim 23, wherein the strike plate defines an opening that is on a side of a doorframe and wherein the locking tongue body engages in the opening; and the locking tongue retracts and extends into the opening of the doorframe strike plate for locking and unlocking the door.

25. The electric door lock device of claim 24, further comprising an electronic key or a user interface to activate locking or unlocking of the door.

26. The electric door lock device of claim 25, wherein the cam locking member is a blocking block that extends into the groove of the cam after the door is closed to prevent the cam from moving and maintain the door locked.

27. The electric door lock device of claim 26, wherein after inputting the electronic key the electromagnetic module generates a magnetic force to move the blocking block to detach from the groove of the cam and allow a user to move the cam by a door handle or the doorknob to unlock the door.

28. The electric door lock device of claim 27, wherein the blocking block further includes a blocking block spring disposed thereon for engaging the blocking block into the groove of the cam when the magnetic force is not activated.

29. The electric door lock device of claim 25, wherein the electric module further includes an expansion block that engages a telescopic rod., wherein after a door handle or the doorknob is moved the cam moves the locking tongue to extend and lock the door.

30. The electric door lock device of claim 29, wherein after inputting the electronic key or the user interface the electric module drives the expansion block to extend and the expansion block drives the telescopic rod to move and drives the cam to move, wherein the cam drives the locking tongue to retract and unlock the door.

31. The electric door lock device of claim 30, wherein the expansion block moves towards the cam when the electric module is activated to unlock the door.

32. An electric door lock device, comprising:
a strike assembly and a deadbolt assembly disposed about a doorframe and a door;
the strike assembly including a power source for delivering electricity to a strike electrode or an energy transmission end; the strike electrode or the energy transmission end having an opening on one side of the door frame;
the deadbolt assembly including a deadbolt electrode or an energy receiving end, a moving mechanism, and a locking tongue;
wherein, after the door is closed the power source delivers electricity to the strike electrode or the energy transmission end that powers the deadbolt electrode or the energy receiving end that supplies power to the moving mechanism;
a user interface or an electronic key for controlling the electric door lock device; and
wherein after a user inputs a lock closing command the moving mechanism receives the command and drives the locking tongue to extend into the opening and lock the door.

33. The electric door lock device of claim 32 wherein a wireless charging means includes the energy transmission end and the energy receiving end; and the wireless charging means is either contact wireless charging or non-contact wireless charging.

34. The electric door lock device of claim 32 wherein the moving mechanism is a printed circuit board assembly (PCBA), a cam, a cam gear, a motor gearbox, or any combination thereof in communication with each other, and wherein the cam gear drives the locking tongue to extend into the opening and lock the door.

35. The electric door lock device of claim 34, wherein after the door is closed the power source delivers electricity to the strike electrode that powers the deadbolt electrode that supplies power to the PCBA, and the PCBA powers the motor gear box.

36. The electric door lock of claim 35, wherein the PCBA receives the lock closing command and allows the motor gearbox to drive the cam gear to move; wherein the cam gear drives the locking tongue to lock the door.

37. An electric door lock device, comprising:
a strike assembly and a deadbolt assembly disposed about a doorframe and a door;
the strike assembly including a power source for delivering electricity to a strike electrode or an energy transmission end; the strike electrode or the energy transmission end having an opening on one side of the door frame;
the deadbolt assembly including a deadbolt electrode or an energy receiving end, a moving mechanism, and a locking tongue;
wherein, after the door is closed the power source delivers electricity to the strike electrode or the energy transmission end that powers the deadbolt electrode or the energy receiving end that supplies power to the moving mechanism;
a user interface or an electronic key for controlling the electric door lock device; and
wherein after a user inputs a lock unlocking command the moving mechanism receives the command and drives the locking tongue to retract from the strike assembly and unlock the door.

38. An electric door lock device of claim 37, wherein a wireless charging means includes the energy transmission end and the energy receiving end; and the wireless charging means is either contact wireless charging or non-contact wireless charging.

39. An electric door lock device, comprising:
a strike assembly and a deadbolt assembly disposed about a doorframe having an opening on one side and a door;
the strike assembly including a power source for delivering electricity to an electrode 1 or an energy transmission end; wherein the electrode 1 or the energy transmission end delivers power to an electrode 2 or an energy receiving end;
the deadbolt assembly including a printed circuit board assembly (PCBA) in communication with electrode 2 or the energy receiving end through conducting medium and a moving mechanism in communication with a locking tongue;
wherein, after the door is closed the power source delivers electricity to the electrode 1 or a strike electrode or the energy transmission end that powers the electrode 2 or a deadbolt electrode or the energy receiving end that supplies power to the PCBA, and the PCBA powers the moving mechanism;
a user interface or an electronic key for controlling the electric door lock device; and
wherein after a command is inputted in the user interface or the electronic key, the PCBA receives the command and allows the moving mechanism to move that drives the locking tongue to retract and unlock the door.

40. An electric door lock device of claim 39, wherein a wireless charging means includes the energy transmission end and the energy receiving end; and the wireless charging means is either contact wireless charging or non-contact wireless charging.

41. The electric door lock device of claim 39, wherein the moving mechanism includes a motor gear box, a cam, and a cam gear; and wherein after the user inputs an unlocking command the PCBA receives the command and allows the motor gear box to reverse drive the cam gear to move; and wherein the cam gear drives the cam to move that drives the locking tongue to retract from the opening in the door frame and unlock the door.

42. The electric door lock device of claim 39, wherein the strike assembly contains the opening on the one side of the door frame.

43. The electric door lock device of claim 39, wherein the PCBA has a capacitor for storing electricity for a motor to move a motor gear box; a cam; a cam gear; a locking tongue.

44. The electric door lock device of claim 39, wherein the PCBA powers a motor gear box to drive a cam gear to move; and wherein the cam gear drives a cam to move that drives the locking tongue to extend into the opening and lock the door.
